(19) United States
(12) Patent Application Publication
(10) Pub. No.: US 2004/0016874 A1
(43) Pub. Date: Jan. 29, 2004

(54) AUTOMATIC POLARIZATION CONTROLLER FOR POLARIZATION MULTIPLEXED OPTICAL SIGNALS

(76) Inventors: Hemonth G. Rao, Burlington, MA (US); Michael J. LaGasse, Lexington, MA (US); John M. Jacob, Bedford, MA (US)

Correspondence Address: RAUSCHENBACH PATENT LAW GROUP, LLC, P.O. BOX 387, BEDFORD, MA, 01730, US

(21) Appl. No.: 09/769,671

(22) Filed: Jan. 25, 2001

(51) Int. Cl. G02F 1/01

(52) U.S. Cl. 250/225

(57) ABSTRACT

An automatic polarization controller is described that includes an optical input that receives a polarization multiplexed optical pulse train that comprises a first and a second polarized optical pulse train. A dither modulation signal is superimposed on at least one of the first and the second polarized optical pulse trains. A polarization transformer transforms an input polarization state of the polarization multiplexed optical pulse train to an output polarization state in response to a control signal that is applied to a control input of the polarization transformer. A polarization selective element receives the transformed polarization multiplexed optical pulse train and passes a polarized optical pulse train including the dither modulation signal. A detector receives the polarized optical pulse train including the superimposed dither modulation signal and generates a signal that is proportional to the amplitude of the dither modulation signal. A feedback control unit receives the signal generated by the detector and generates a control signal that is coupled to the control input of the polarization transformer. The polarization transformer adjusts the polarization state of the polarized optical pulse train in response to the control signal.

### FIELD OF THE INVENTION

The present invention relates to controlling the polarization of optical signals. In particular, the present invention relates to methods and apparatus for controlling the polarization of polarization multiplexed signals.

### BACKGROUND OF THE INVENTION

Optical fiber communication systems generally use standard single mode optical fiber, which does not preserve the polarization of the optical signals propagating in the fibers. When optical signals are transmitted through standard single mode optical fiber, the polarization of the signals is randomized. Polarization transformers can be used to transform the fluctuating output polarization state of the optical fiber into a stable state of polarization (SOP). Once a stable state of polarization is recovered, polarization-sensitive optical components can be used to process the received optical signals. Polarization-sensitive optical components are used for numerous applications, such as polarization demultiplexing, coherent optical detection, and fast electrooptic switch arrays.

There are several prior art polarization transformers that have effectively unlimited polarization transformation ranges. One type of polarization transformer uses mechanical effects to control the polarization optical fiber. Such polarization transformers use cascaded electromagnetic or piezo-electric based optical fiber squeezers. Fiber squeezing polarization transformers, however, have response times that are much slower than the rate at which the polarization changes. One reason for the slow response time is that individual fiber squeezing elements have to be reset without affecting the overall polarization transformation.

Another type of polarization transformer uses cascaded endlessly rotatable optical retardation plates. Such controllers do not require reset cycles and, therefore, can be operated with a simple and relatively fast control algorithm. For example, one prior art polarization transformer uses a single quarter-wave plate followed by a half-wave plate to achieve endless, reset-free transformations from any varying general input state of polarization into an arbitrary linear output state of polarization.

Another prior art polarization transformer uses a first quarter-wave plate followed by a half-wave plate and then a second quarter-wave plate to achieve endless, reset-free transformations from any arbitrarily varying input state of polarization into an arbitrary output state of polarization. The speed of polarization transformers that use cascaded endlessly rotatable optical retardation plates is limited by the mechanical rotation speeds of wave plates. The wave plates may be bulk-optic or fiber optic waveplates. Yet another type of polarization transformer uses electro-optically induced retardation plates in either bulk optic or integrated-optic form.

Many optical fiber communication systems require automatic polarization control to continuously transform the fluctuating output polarization state of the optical fiber into a stable state of polarization (SOP). Automatic polarization controllers generate an error signal in response to the output of the polarization controller. The error signal is fed back to an electronic controller that generates a signal that controls a polarization transformer in the controller. Some electronic controllers manipulate the polarization transform in such a way as to minimize the error signal or drive the error signal to zero or some acceptably low value. Other electronic controllers manipulate the polarization transform in such a way as to maximize the error signal or drive the error signal to a desired value.

Prior art automatic polarization controllers perform simple power measurements on either the desired polarization state or other known undesired polarization states, such as orthogonal polarization states of an polarization multiplexed signal. Prior art automatic polarization controllers, thus cannot determine the relative power in two components of a polarization multiplexed signal.

### SUMMARY OF THE INVENTION

The present invention relates to automatic polarization controllers that continuously transform an input optical signal having an unknown or random polarization state to a desired polarization state, so that optical processing can be performed by polarization dependent optical components. An automatic polarization controller of the present invention amplitude modulates the input optical signal with a relatively low-frequency, small-signal amplitude to identify components of a polarization-multiplexed optical signal.

One advantage of the automatic polarization controller of the present invention is that the controller can measure the degree-of-polarization in a polarization multiplexed optical pulse train. The degree-of-polarization is a useful metric for quantifying polarization mode dispersion (PMD) and predicting the onset of a PMD fade. Another advantage of the automatic polarization controller of the present invention is that it is tolerant to noise generated by un-modulated light in the transformed optical pulse trains.

Accordingly, the present invention features an automatic polarization controller that includes an optical input that receives a polarization multiplexed optical pulse train that includes a first and a second polarized optical pulse train. The polarization multiplexed optical pulse train may be received from an optical fiber. The polarization multiplexed optical pulse train may comprise two orthogonally polarized pulse trains. In one embodiment, the optical input receives a polarization multiplexed optical pulse train comprising a bit interleaved polarization multiplexed optical pulse train. A dither modulation signal is superimposed on at least one of the first and the second polarized optical pulse train.

A polarization transformer transforms an input polarization state of the polarization multiplexed optical pulse train to an output polarization state in response to a control signal that is applied to a control input of the polarization transformer. The polarization transformer can be any type of polarization transformer. For example, in one embodiment, the polarization transformer is an electro-optic polarization transformer that may be formed on a lithium niobate substrate.

In another embodiment, the polarization controller is a liquid crystal polarization transformer. In another embodiment, the polarization controller is a solid-state polarization transformer. In another embodiment, the polarization controller is a bulk optical polarization transformer. In yet another embodiment, the polarization controller includes at least two endlessly rotatable waveplates. At least one of the endlessly rotatable waveplates may be a variable thickness waveplate. In addition, the polarization controller may be a combination of two or more polarization controllers of the same or a different type. A polarization selective element receives the transformed polarization multiplexed optical pulse train and passes a polarized optical pulse train including the dither modulation signal. A detector receives the polarized optical pulse train including the superimposed dither modulation signal and generates a signal that is proportional to the amplitude of the dither modulation signal. In one embodiment, the detector is a narrow-band detector.

A feedback control unit receives the signal generated by the detector and generates a control signal that is coupled to the control input of the polarization transformer. In one embodiment, the feedback control unit generates an electrical control signal. In another embodiment, the feedback control unit generates an optical control signal. The polarization transformer adjusts the polarization state of the polarized optical pulse train in response to the control signal.

The present invention also features an automatic polarization controller that includes an optical input that receives a polarization multiplexed optical pulse train that comprises a first and a second orthogonally polarized optical pulse train. In one embodiment, the optical input receives a polarization multiplexed optical pulse train comprising a bit interleaved orthogonally polarized polarization multiplexed optical pulse train. A dither modulation signal is superimposed on at least one of the first and the second polarized optical pulse train.

A polarization transformer transforms an input polarization state of the polarization multiplexed optical pulse train to an output polarization state in response to a control signal that is applied to a control input of the polarization transformer. In one embodiment, the polarization transformer is an electro-optic polarization transformer that may be formed on a lithium niobate substrate. In another embodiment, the polarization controller is a liquid crystal polarization transformer. In another embodiment, the polarization controller is a solid-state polarization transformer. In another embodiment, the polarization controller is a bulk optical polarization transformer. In yet another embodiment, the polarization controller includes at least two endlessly rotatable waveplates. At least one of the endlessly rotatable waveplates may be a variable thickness waveplate.

A polarization beam splitter receives the transformed polarization multiplexed optical pulse train and passes a first and a second orthogonally polarized optical pulse train including the first and the second dither modulation signal, respectively. A detector receives one of the first and the second polarized optical pulse train including the first and the second dither modulation signal and generates a signal that is proportional to the amplitude of at least one of the first and the second dither modulation signal. In one embodiment, the detector is a narrow-band detector. In one embodiment, the detector generates a first and a second signal that is proportional to the amplitude of the first and the second dither modulation signal, respectively.

A feedback control unit receives the signal generated by the detector and generates a control signal that is coupled to the control input of the polarization transformer. In one embodiment, the feedback control unit generates an electrical control signal. In another embodiment, the feedback control unit generates an optical control signal. The polarization transformer adjusts the polarization state of the polarized optical pulse train in response to the control signal.

The present invention also features a method of transforming a polarization state of a polarization multiplexed optical signal. The method includes receiving a polarization multiplexed optical pulse train including a first and a second polarized optical pulse train. The first and the second polarized optical pulse train may be orthogonally polarized optical pulse trains. The first and the second polarized optical pulse train may also be a bit interleaved polarization multiplexed optical pulse train. A first and a second dither modulation signal are superimposed on the first and the second polarized optical pulse train, respectively.

The polarization multiplexed optical pulse train is transformed from an input polarization state to an output polarization state. The transformed polarization multiplexed optical signal is separated into a first and a second polarized optical pulse train, respectively. An amplitude of at least one of the first and the second dither modulation signal is detected.

A control signal having an amplitude that is proportional to the detected amplitude of the at least one of the first and the second dither modulation signal is generated. In one embodiment, a first and a second control signal is generated where the amplitude of the first and second control signal is proportional to the detected amplitude of the first and the second dither modulation signal, respectively. The transformation is adjusted in response to the generated control signal. In one embodiment, the transformation is adjusting to reduce the amplitude of the control signal.

### BRIEF DESCRIPTION OF THE DRAWINGS

This invention is described with particularity in the appended claims. The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 illustrates a block diagram of a polarization multiplexed optical fiber communication system according to the present invention.

FIG. 2 illustrates a block diagram of a polarization division multiplexer according to the present invention that generates a polarization multiplexed optical signal.

FIG. 3 illustrates a polarization multiplexed orthogonally polarized bit interleaved pulse train that can be generated by the polarization division multiplexer of FIG. 2.

FIG. 4 illustrates a schematic block diagram of one embodiment of an automatic polarization controller according to the present invention.

### DETAILED DESCRIPTION

Optical multiplexing is required for Optical Time-Division Multiplexing (OTDM) communication systems. Optical multiplexing is described in U.S. patent application Ser. No. 09/566,303, entitled Bit Interleaved Optical Multiplexer, which is assigned to the present assignee. The entire disclosure of U.S. patent application Ser. No. 09/566,303 is incorporated herein by reference.

Optical polarization-division multiplexing (PDM) is a type of optical multiplexing that multiplexes polarized optical pulse trains into a single bit interleaved optical pulse train having at least two polarization. Standard single-mode optical fibers can support PDM because two orthogonal states of polarization can exist in the fundamental mode of single mode optical fiber. The relative orthogonal nature of the polarization is preserved in standard single mode optical fibers even though the polarization states of the optical pulse trains change in a random manner as the pulse trains propagate. This assumes that polarization effects, such as polarization mode dispersion (PMD) and polarization-dependent loss (PDL) are not significant enough to destroy the orthogonal nature of the polarization in the polarized pulse trains.

PDM communication systems have numerous advantages over non-PDM communication systems. One advantage of the PDM communication system is that it has greater spectral efficiency compared with non-PDM systems. This is because data propagates in two orthogonally polarized pulse trains at a single wavelength. Thus, PDM effectively doubles the data capacity. Another advantage is that PDM communication systems have higher dispersion tolerance as compared with non-PDM systems. The dispersion tolerance of PDM communication systems can be four times greater than comparable non-PDM systems.

Relatively simple optical techniques known in the art can be used to isolate each of the two orthogonally polarized pulse trains. The absolute polarization of the two orthogonally polarized pulse trains is, however, not preserved as the optical pulse trains propagate. A polarization transformer is required in PDM systems to align the absolute polarization state of the two orthogonally polarized optical pulse trains so the data in the two pulse trains can be processed.

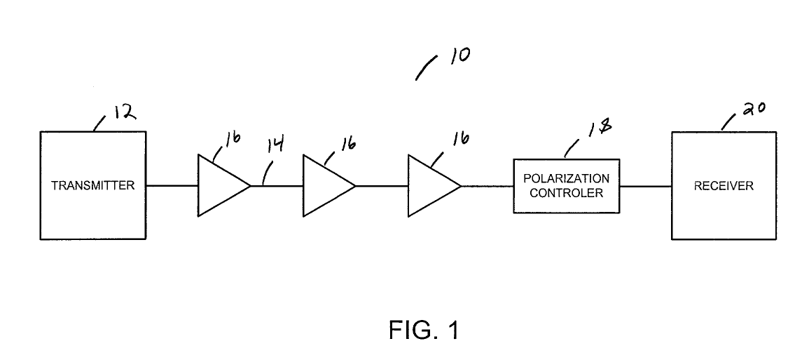

Referring more particularly to the figures, FIG. 1 illustrates a block diagram of a polarization multiplexed optical fiber communication system 10 according to the present invention. The communication system 10 includes an optical polarization multiplexed transmitter 12 that generates a polarization multiplexed bit interleaved optical pulse train. In one embodiment of the present invention, every other bit in the polarization multiplexed bit interleaved optical pulse train has the same polarization. The optical pulse train is transmitted though an optical fiber communication link 14.

The communication link 14 may include numerous repeaters or regenerators 16 that are positioned along the link 14. When the link 14 length exceeds a certain distance, depending on the operating wavelength, the signals comprising the optical pulse train become too weak to be reliably detected. Repeaters or regenerators 16 are periodically placed along the link 14 to compensate for loss introduced by the optical fiber. Electrical regenerators include receiver-transmitter pairs that detect the incoming optical signal, recover the electrical pulse train, and then convert the electrical pulse train back into an optical pulse train having desired signal levels. Other systems use repeaters that include all-optical amplifiers. One disadvantage of optical amplifiers is that they add noise and do not compensate for fiber dispersion or other optical nonlinearities.

A polarization controller or polarization transformer 18 receives the polarization multiplexed bit interleaved optical pulse train that was transmitted though the optical fiber communication link 14. The absolute polarization of the two orthogonally polarized bit interleaved optical pulse trains received by the polarization transformer is unknown. The polarization transformer 18 transforms the arbitrarily polarization state of the bit interleaved optical pulse trains into a known stable state of polarization so that it can be processed by polarization sensitive components.

An optical receiver 20 receives the multiplexed bit interleaved optical pulse train having a known state of polarization and processes the pulse train into data or signals. The receiver generally includes a detector and may be preceded by a polarization division demultiplexer. In addition, signal processing circuits transform the data or signals into useful information.

FIG. 2 illustrates a block diagram of a polarization division multiplexer 50 according to the present invention that generates a polarization multiplexed optical signal. In one embodiment, the polarization division multiplexer 50 is an OTDM transmitter. The multiplexer 50 includes an optical splitter 52 that receives an optical clock signal 54 at an input 56 and splits the optical clock signal 54 into a plurality of channels or arms 58, where each arm 58 comprises an optical waveguide.

In one embodiment, the optical waveguides comprising the arms 58 are polarization maintaining optical fibers. The splitter 52 can be any type of optical splitter. In one embodiment, the splitter 52 comprises a 1×N fused fiber coupler, where N is the number of arms. In another embodiment, the splitter 52 comprises an integrated optical waveguide splitter. In another embodiment, the splitter 52 is a polarization maintaining splitter.

The polarization division multiplexer 50 also includes a plurality of modulators 60. Any type of modulator can be used. For example, the modulators 60 may be electro-optic modulators, electro-absorption modulators, liquid crystal modulators, solid-state modulators, or polymer modulators. A respective one of the plurality of modulators 60 is optically coupled to a respective one of the plurality of arms 58. In one embodiment, polarization maintaining optical fiber is used to optically couple each of the plurality of modulators 60 to one of the plurality of arms 58.

Each of the plurality of modulators 60 includes an electrical modulation signal input 62 that receives an electrical modulation signal. A respective one of the plurality of modulators 60 modulates the optical clock signal 54 propagating in a respective one of the plurality of arms 58 with an electrical modulation signal and generates a modulated optical signal at an optical output 64. The electro-optic modulators may be any kind of electro-optical modulator, such as a Mach-Zehnder interferometric modulator, electro-absorption modulator, liquid crystal, solid state, or a polymer modulator.

In one embodiment, the modulators 60 are lithium niobate Mach-Zehnder interferometric electro-optic modulators. The operation of Mach-Zehnder interferometric modulators are well known in the art. The refractive index of the lithium niobate electro-optic material changes with the application of an external modulation voltage. When no external modulation voltage is applied to the modulator, the refractive index of the lithium niobate in both arms of the interferometer is substantially the same. If the path length difference between the two arms of the interferometer is π, the optical fields in the two arms of interferometer destructively interfere and, consequently, no light is transmitted through the modulator. Thus, when no external modulation voltage is applied, the modulator generates a “0” bit.

When an external modulation voltage is applied to the Mach-Zehnder interferometric modulator, an additional phase shift is introduced in one of the arms of the interferometer. A voltage-induced refractive index change in one of the arms causes constructive interference and the modulator transmits or passes light. Thus, when an external modulation voltage is applied, the modulator generates a “1” bit or “high” signal. Therefore, each of the modulators generates an optical pulse train that is an optical replica of the electrical modulation signal applied to the modulator.

The polarization division multiplexer 50 includes a plurality of electrical modulation sources 66. A respective one of the plurality of electrical modulation sources 66 is electrically connected to the electrical modulation signal input 62 of a respective one of the plurality of modulators 60. The electrical modulation sources 66 may be separate and independent modulation sources or may be one or more modulation sources having multiple outputs.

Each of the plurality of electrical modulation sources 66 includes a data modulation source and a dither modulation source. The data modulation source generates a data signal. In one embodiment, the data signals generated by each of the electrical modulation sources have a relative phase that aligns each bit of the optical pulse trains in the desired bit order. By desired bit order, we mean the desired position of one bit relative to another bit in a pulse train.

The dither modulation source generates a dither modulation signal that is used to identify or tag a polarization state of the modulated optical data signal. The dither modulation signal can be any frequency and any amplitude. In one embodiment, the dither modulation signal is a relatively low-frequency, small-signal amplitude modulation frequency. In one embodiment, the polarization division multiplexer 50 uses two different modulation frequencies.

In one embodiment, the polarization division multiplexer 50 uses two dither modulation frequencies. A first dither modulation frequency is used for the first polarization and a second dither modulation frequency is used for the second polarization. In this embodiment, a four-channel polarization division multiplexer, for example, may use a dither modulation source having a first frequency for the first and second channel and may use a dither modulation source having a second frequency for the third and fourth channel. Any number of dither modulation signals can be used.

Polarization division multiplexers having more than two arms 58 include at least two optical combiners. The optical combiners combine the optical pulse trains propagating in each of the plurality of arms 58 into two bit interleaved pulse trains. In one embodiment, the multiplexer 50 includes a first 68 and a second optical combiner 68′ and each of the first 68 and second optical combiner 68′ has N/2 inputs, where N is the number of arms 58.

In other embodiments, the multiplexer 50 includes cascaded combinations of low-order optical combiners, such as 1×2 or 1×4 optical combiners, that are configured to produce two bit interleaved pulse trains. Each of the optical combiners has a plurality of optical inputs 70 and an optical output 72. In one embodiment, the combiners are constructed from polarization maintaining optical fiber.

A respective one of the plurality of optical inputs 70 of each of the two optical combiners 68, 68′ is optically coupled to an optical output 64 of a respective one of the plurality of modulator 60. In one embodiment, polarization maintaining optical fiber is used to couple the optical outputs 64 of the modulators 60 to the optical inputs 70 of the optical combiner 68, 68′. The optical combiners 68, 68′ assemble or combine the independently modulated optical pulse trains propagating in each of the plurality of arms 58 into a first 75 and a second bit interleaved pulse train 75′. In one embodiment, the independently modulated optical pulse trains have the same polarization.

A polarization beam splitter/combiner 74 assembles or combines the first 75 and the second bit interleaved pulse train 75′, into a single orthogonally polarized bit interleaved pulse train 75′. In one embodiment, the polarization beam combiner 74 assembles or combines the first 75 and the second bit interleaved pulse train 75′ into a linearly and orthogonally polarized bit interleaved pulse train 75″. It is usually desirable for the first 75 and the second bit interleaved pulse train 75′ to be combined into an orthogonally polarized bit interleaved pulse train 75″. The first 75 and the second bit interleaved pulse train 75′ may be aligned for maximum transmission through the beam combiner.

The polarization beam combiner 74 has a first 76 and a second optical input 76′ that are optically coupled to the first 72 and the second optical output 72′ of the first 68 and the second optical combiner 68′, respectively. In one embodiment, polarization maintaining optical fiber is used to couple the optical outputs 72, 72′ of the optical combiners 68, 68′ to the optical inputs 76, 76′ of the polarization beam combiner 74.

The polarization beam combiner 74 generates a polarization multiplexed bit interleaved optical pulse train 75″ that comprises the two orthogonally polarized bit interleaved pulse trains 75, 75′. Every other bit in the polarization multiplexed bit interleaved optical pulse train 75″ has the same polarization. The absolute polarization of the two orthogonally polarized bit interleaved pulse trains may be known or unknown at the output of the polarization beam combiner 74. The position of each bit in the polarization multiplexed bit interleaved optical pulse train 75″ is determined by both the optical path length propagating the bit and by the relative phase of the modulation signal that generated the bit.

The optical path length determines the relative position of the bits in the pulse train. The relative phase of the modulation signal determines the relative order of the bits in the pulse train. The phase of each of the electrical modulation signals is adjusted to position the bits in the desired order with the desired polarization state. In one embodiment, the phase of each of the electrical modulation signals is adjusted so that every other bit in the polarization multiplexed bit interleaved pulse train has the same polarization. That is, the bits in the pulse train alternate from the first polarization to the second polarization.

The multiplexer 50 of the present invention has numerous advantages over the prior art. One advantage of the multiplexer 50 of the present invention is that it has relatively high spectral efficiency because data propagates in two orthogonally polarized pulse trains at a single wavelength. Another advantage of the multiplexer 50 is that the dispersion tolerance is significantly improved by orthogonally polarizing every other bit in the bit interleaved pulse train. Yet another advantage of the multiplexer 50 is that jitter timing is significantly reduced by orthogonally polarizing every other bit in the bit interleaved pulse train.

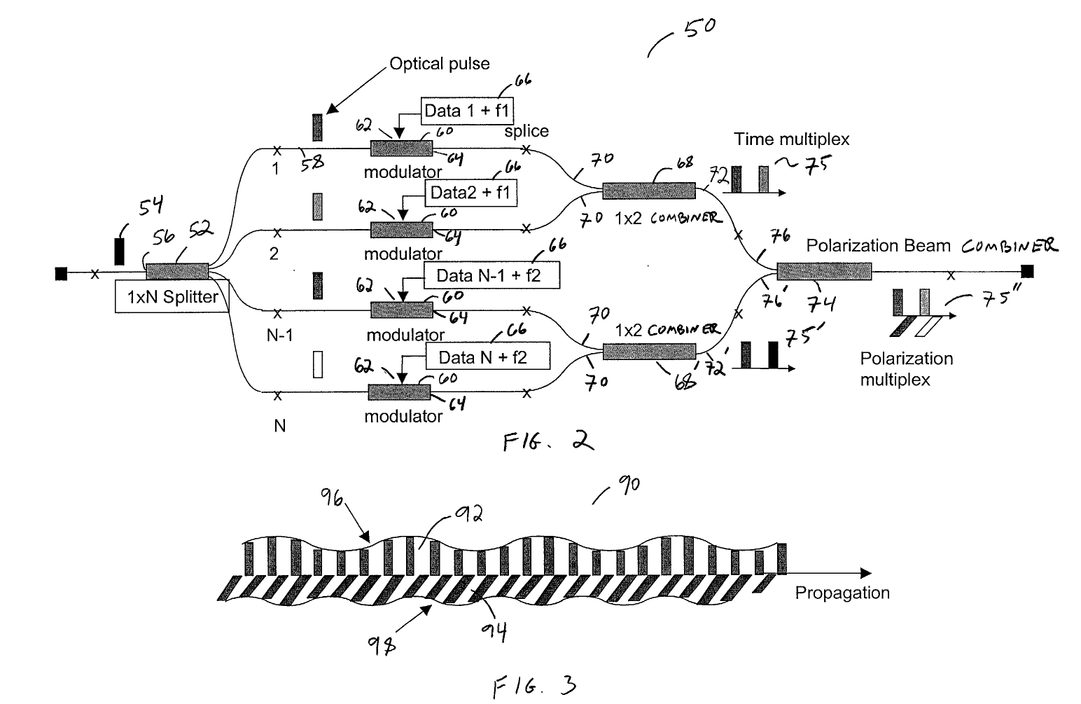

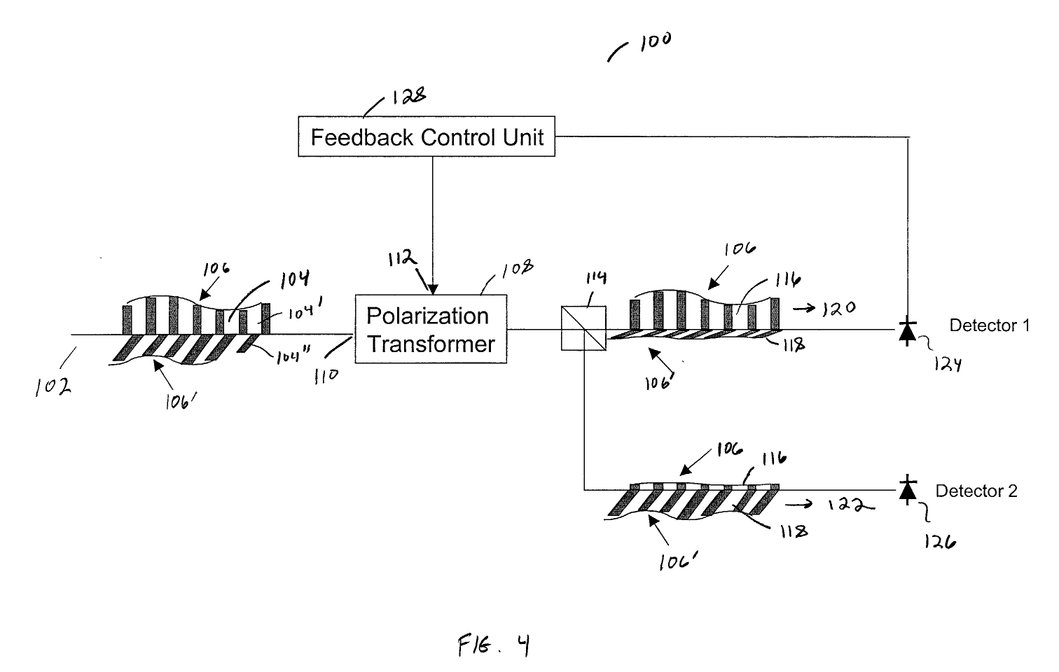

FIG. 3 illustrates a polarization multiplexed orthogonally polarized bit interleaved pulse train 90 that can be generated by the polarization division multiplexer 50 described in connection with FIG. 2. The pulse train 90 includes a first 92 and a second polarized bit interleaved pulse train 94, which propagate in orthogonal direction. A first 96 and a second dither modulation signal 98 are superimposed on the first 92 and the second polarized bit interleaved pulse train 94.

FIG. 4 illustrates a schematic block diagram of one embodiment of an automatic polarization controller 100 according to the present invention. The automatic polarization controller 100 is used to align the absolute polarization state of a polarization multiplexed optical pulse train to a desired polarization state. The automatic polarization controller 100 includes an optical input 102 that receives a polarization multiplexed optical pulse train 104 that was transmitted across a communication link.

The polarization multiplexed optical pulse train 104 may be any type of multiplexed optical signal. In one embodiment of the invention, the polarization multiplexed optical pulse train 104 comprises an orthogonally polarized bit interleaved polarization multiplexed optical pulse train, such as the pulse train 75″ that was described in connection with the multiplexer of FIG. 2. In this embodiment, the optical pulse train 104 includes a first 104′ and a second orthogonally polarized bit interleaved polarization multiplexed optical pulse train 104″.

The polarization multiplexed optical pulse train 104 includes at least one dither modulation signal that identifies or tags a polarization state of the optical pulse train 104. In one embodiment, the polarization multiplexed optical pulse train 104 includes a first 106 and a second dither modulation signal 106′ that are superimposed on the first 104′ and the second orthogonally polarized bit interleaved polarization multiplexed optical pulse train 104″.

The absolute polarization of the first 104′ and the second orthogonally polarized bit interleaved polarization multiplexed optical pulse train 104″ is typically unknown because the absolute polarization of the optical pulse train varies across the communication link in an unpredictable manner. The automatic polarization controller 100 is used to align the absolute polarization state of two orthogonally polarized pulse trains to a desired polarization state.

The automatic polarization controller 100 also includes a polarization transformer 108. The polarization transformer 108 includes an optical input 110 that receives the polarization multiplexed optical pulse train 104. The polarization transformer 108 also includes a control input 112 that receives a control signal. In one embodiment, the control signal is an electrical control signal. In another embodiment, the control signal is an optical signal.

The polarization transformer 108 modifies the polarization state of the polarization multiplexed optical pulse train 104 in response to the control signal applied to the control input 112. In some situations, the control signal is substantially zero and the polarization transformer 108 does not significantly modify the polarization state of the polarization multiplexed optical pulse train 104. The polarization transformer 108 transforms the polarization of the polarization multiplexed optical pulse train 104 into a desired polarization state.

The polarization transformer 108 may be any type of polarization transformer. In one embodiment, the polarization transformer 108 uses electro-optically induced retardation plates in either bulk optic or integrated-optic form. Integrated optic polarization transformers are advantageous because they are relatively fast, compact, require relatively low drive voltages, and have low coupling losses to single-mode optical fibers. In one embodiment, the electro-optic polarization transformer includes cascaded electrode sections. Each of the electrode sections function as an endlessly rotatable wave plate and produces a fixed amount of linear phase retardation. The polarization transformer 108 may include any number of electrode sections.

For example, a polarization transformer 108 according to the present invention may be an integrated optical polarization transformer comprising three cascaded electrode sections, where each electrode section functions as endlessly rotatable wave plate. The first and third sections function as quarter-wave plates. The second section functions as a half-wave plate. The electrode sections may be fabricated from titanium-indiffused single-mode waveguides formed in a lithium niobate substrate. The polarization transformer according to the present invention can include any number of cascaded electrode sections.

In operation, each section of the polarization transformer produces a fixed amount of linear phase retardation by electro-optically inducing a variable combination of TE-TM mode conversion and relative TE-TM phase shifting. The orientation of the inducing linear birefringence is endlessly adjustable by varying the relative amounts of mode conversion and phase shifting.

In other embodiments of the invention, the polarization transformer 108 is an electro-optical liquid crystal polarization controller. In another embodiment, the polarization transformer 108 may be a fiber polarization transformer. In yet another embedment, the polarization transformer is an electro-optical solid-state polarization controller. For example, the polarization transformer may be an opto-ceramic polarization controller, such as the Acrobat polarization controller manufactured by Corning Applied Technologies.

In yet another embodiment, the polarization transformer 108 comprises a cascaded combination of polarization transformers. The cascaded combination of polarization transformers 108 can comprise a cascaded combination of the same type or different types of polarization transformers. For example, the cascaded combination of polarization transformers 108 may be a combination of a course and a fine polarization transformer.

A polarization beam splitter 114 is positioned in the optical path of the transformed polarization multiplexed bit interleaved optical pulse train. The polarization beam splitter 114 separates or splits the transformed polarization multiplexed bit interleaved optical pulse train into a first 116 and a second polarized optical pulse train 118 that propagate in a first 120 and a second path 122. In other embodiments, any type of polarization selective element can be used to isolate at least one polarized optical pulse train including a dither modulation signal. In one embodiment, the first 116 and second polarized optical pulse train 118 include the first 106 and a second dither modulation signal 106′, respectively. In other embodiments, at least one of the first 116 and second polarized optical pulse train 118 includes a dither modulation signal.

In practice, the polarization beam splitter 114 does not perfectly separate or split the transformed polarization multiplexed bit interleaved optical pulse train into the first 116 and the second polarized optical pulse train 118. The optical pulse train propagating in the first 120 and the second path 122 include some of the second 118 and the first polarized optical pulse train 116, respectively. That is, the optical pulse train propagating in the first path 120 includes some leakage signal comprising the second polarized optical pulse train 118 with the second dither modulation signal 106′. Similarly, the optical pulse train propagating in the second path 122 includes some leakage signal comprising the first polarized optical pulse train 116 with the first dither modulation signal 106.

A first 124 and a second detector 126 are positioned in the first 120 and the second path 122, respectively. The first 124 and the second detector 126 generate a signal that is proportional to the amplitude of one of the dither modulation signals superimposed on the polarized optical pulse trains propagating in the first 120 and the second path 122. In one embodiment, the first 124 and the second detector 126 are photodiodes that generate an electrical output signal that is proportional to the amplitude of one of the dither modulation signal.

In one embodiment, each of the first 124 and the second detector 126 independently measures the amplitude of the first 106 and the second dither modulation signal 106′ in the received polarized optical pulse train. The first 124 and the second detector 126 perform narrow-band detection. Narrow-band detection is well known in the art. Any type of narrow band detector can be used. The first 124 and the second detector 126 detect one of the dither modulation signals and reject substantially all other signals.

A feedback control unit 128 is electrically coupled to at least one of the first 124 and the second optical detector 126 and generates a control signal that is electrically coupled to the control input 112 of the polarization transformer 108. The signal generated by the feedback control unit 128 causes the polarization transformer 108 to adjust the polarization state of the first 116 and the second polarized optical pulse train 118 to desired polarization states. Thus, the automatic polarization controller 100 of the present invention transforms the input polarization multiplexed optical signal into a first 116 and second polarized optical pulse train 118 having desired absolute output polarization states. The transformed polarization multiplexed optical signal can then be optically processed with optical techniques known in the art.

In one embodiment, at least one of the first 124 and the second detector 126 generates an error signal. The amplitude of the error signal is proportional to the amplitude of the leakage dither modulation signal. For example, the amplitude of the error signal generated by the first detector 124 is proportional to the amplitude of the second dither modulation signal 106′ superimposed on the second polarized optical pulse train 118. In this embodiment, the feedback control unit 128 manipulates the polarization transformer 108 in such a way as to drive the error signal to zero or some acceptable low value.

One advantage of the automatic polarization controller of the present invention is that two power measurements can be made on each of two orthogonally polarized pulse train. This is in contrast to prior art automatic polarization controllers that perform a simple power measurement on either the desired polarization state or another known polarization state, such as an orthogonal polarization state. Thus, the automatic polarization controller of the present invention can determine the relative power in two orthogonal components in a polarization multiplexed signal and then can perform the desired polarization transform to produce two orthogonally polarized pulse trains with minimal leakage power.

One important application of the automatic polarization transformer of the present invention is that it can be used to measure the optical Degree of Polarization (DOP). Degree of polarization is the ratio of the intensity of the polarized portion of an optical signal to the total intensity of the optical signal. Degree of polarization measurements are useful in quantifying degradation due to Polarization Mode Dispersion (PMD). Measurements of DOP can also be used to indicate the onset of a signal fade due to PMD.

Polarization mode dispersion is a well known phenomenon that is caused by birefringence in optical fibers. Optical fibers have small departures from perfect cylindrical symmetry. These small departures result in an optical birefringence. Even the best optical fibers exhibit residual birefringence that varies along the fiber because of stress and core diameter variations. When optical pulses propagating in the optical fiber excite both polarization components, the pulses depolarize or broaden because the two polarization components propagate along the fiber at different group velocities. This causes a relative delay between the two polarization components of the optical signal. PMD seriously limits the use of polarization mode multiplexing in linear systems.

For example, the DOP of the first polarized optical pulse train 116 can be measured with the automatic polarization controller 100 of FIG. 4 by determining the amplitude of the first modulation frequency 106 in the first path 120 and the amplitude of the first modulation signal 106 in the second path 122. The degree of polarization can be determined by the following expression, where f1 (detector1) is the amplitude of the first modulation frequency in the first path 120 and f1 (Detector2) is the amplitude of the first modulation signal 106 in the second path 122.

$$DOP = \frac{f1 ( Detector 1 ) - f1 ( Detector 2 )}{f1 ( Detector 1 ) + f1 ( Detector 2 )}$$

Another important application of the automatic polarization transformer of the present invention 100 is that it can be used to distinguish signals generated by the transmitter from signals added during propagation. In long-haul transmission systems, the most significant source of added signal is amplified spontaneous emission (ASE) that is generated by in-line optical amplifiers that are positioned before the polarization controller. Amplified spontaneous emission is un-modulated and un-polarized light. The automatic polarization controller of the present invention can be configured to remove added signals, such as ASE. The narrow-band detectors used in one embodiment of the automatic polarization controller 100 will substantially remove un-modulated and un-polarized light from the transformed optical pulse trains.

Equivalents

While the invention has been particularly shown and described with reference to specific preferred embodiments, it should be understood by those skilled in the art that various changes in form and detail may be made therein without departing from the spirit and scope of the invention as defined by the appended claims. For example, the automatic polarization controller of the present invention is not limited to use with polarization multiplexed signals, bit interleaved signals, or orthogonally polarized signals.

What is claimed is:

1. An automatic polarization controller comprising:
a. an optical input that receives a polarization multiplexed optical pulse train that includes a first and a second polarized optical pulse train, wherein a dither modulation signal is superimposed on at least one of the first and the second polarized optical pulse train;
b. a polarization transformer that transforms an input polarization state of the polarization multiplexed optical pulse train to an output polarization state, the polarization transformer transforming the polarization state in response to a control signal that is applied to a control input of the polarization transformer;
c. a polarization selective element that receives the transformed polarization multiplexed optical pulse train, the polarization selective element passing a polarized optical pulse train including the dither modulation signal;
d. a detector that receives the polarized optical pulse train including the superimposed dither modulation signal, the detector generating a signal that is proportional to the amplitude of the dither modulation signal; and
e. a feedback control unit that receives the signal generated by the detector and generates a control signal that is coupled to the control input of the polarization transformer, wherein
the control signal generated by the feedback control unit causes the polarization transformer to adjust the polarization state of the polarized optical pulse train.

2. The automatic polarization controller of claim 1 wherein the optical input receives a polarization multiplexed optical pulse train comprising a bit interleaved polarization multiplexed optical pulse train.

3. The automatic polarization controller of claim 1 wherein the optical input receives a polarization multiplexed optical pulse train comprising two orthogonally polarized pulse trains.

4. The automatic polarization controller of claim 1 wherein the polarization multiplexed optical signal is received from an optical fiber.

5. The automatic polarization controller of claim 1 wherein the feedback control unit generates an electrical control signal.

6. The automatic polarization controller of claim 1 wherein the polarization transformer comprises an electro-optic polarization transformer.

7. The automatic polarization controller of claim 6 wherein the electro-optic polarization transformer is formed on a lithium niobate substrate.

8. The automatic polarization controller of claim 1 where the polarization transformer comprises a liquid crystal polarization transformer.

9. The automatic polarization controller of claim 1 where the polarization transformer comprises a solid-state polarization transformer.

10. The automatic polarization controller of claim 1 where the polarization transformer comprises a bulk optical polarization transformer.

11. The automatic polarization controller of claim 1 where the polarization transformer comprises at least two endlessly rotatable waveplates.

12. The automatic polarization controller of claim 1 where the polarization transformer comprises an opto-ceramic polarization transformer.

13. The automatic polarization controller of claim 1 wherein the detector comprises a narrow-band detector.

14. An automatic polarization controller comprising:
a. an optical input that receives a polarization multiplexed optical pulse train that includes a first and a second orthogonally polarized optical pulse train, wherein a first and a second dither modulation signal are superimposed on the first and the second polarized optical pulse train, respectively;
b. a polarization transformer that transforms an input polarization state of the first and the second orthogonally polarized optical pulse train to an output polarization state, the polarization transformer transforming the polarization state in response to a control signal that is applied to a control input of the polarization transformer;
c. a polarization beam splitter that receives the transformed polarization multiplexed optical signal, the polarization beam splitter passing a first and a second orthogonally polarized optical pulse train including the first and the second dither modulation signal, respectively;
d. a detector that receives one of the first and the second polarized optical pulse train including the first and the second dither modulation signal, respectively, the detector generating a signal that is proportional to the amplitude of at least one of the first and the dither modulation signal; and
e. feedback control unit that receives the signal generated by the detector and generates a control signal that is coupled to the control input of the polarization transformer, wherein
the control signal generated by the feedback control unit causes the polarization transformer to adjust the polarization state of at least one of the first and the second polarized optical pulse train.

15. The automatic polarization controller of claim 14 wherein the optical input receives a polarization multiplexed optical pulse train comprising a bit interleaved polarization multiplexed optical pulse train.

16. The automatic polarization controller of claim 14 wherein the detector generates a first and a second signal that is proportional to the amplitude the first and the dither modulation signal, respectively.

17. The automatic polarization controller of claim 14 wherein the detector comprises a narrow-band detector.

18. The automatic polarization controller of claim 14 wherein the polarization transformer comprises an electro-optic polarization transformer.

19. The automatic polarization controller of claim 14 where the polarization transformer comprises a liquid crystal polarization transformer.

20. The automatic polarization controller of claim 14 where the polarization transformer comprises a solid-state polarization transformer.

21. A method of transforming a polarization state of a polarization multiplexed optical signal, the method comprising:
a. receiving a polarization multiplexed optical pulse train comprising a first and a second polarized optical pulse train, wherein a first and a second dither modulation signal are superimposed on the first and the second polarized optical pulse train, respectively;
b. transforming the polarization multiplexed optical pulse train from an input polarization state to an output polarization state, the transformation being responsive to a control signal;
c. separating the transformed polarization multiplexed optical signal into a first and a second polarized optical pulse train, respectively;
d. detecting an amplitude of at least one of the first and the second dither modulation signal;
e. generating a control signal having an amplitude that is proportional to the detected amplitude of the at least one of the first and the second dither modulation signal; and
f. adjusting the transformation in response to the generated control signal.

22. The method of claim 21 wherein the first and the second polarized optical pulse train are orthogonally polarized optical pulse streams.

23. The method of claim 21 wherein the polarization multiplexed optical pulse train comprises a bit interleaved polarization multiplexed optical pulse train.

24. The method of claim 21 wherein the transformation is adjusting to reduce the amplitude of the control signal.

25. The method of claim 21 wherein the generating the control signal comprises generating a first and a second control signal, the amplitude of the first and second control signal being proportional to the detected amplitude of the first and the second dither modulation signal, respectively.
